(19) United States
(12) Patent Application Publication
(10) Pub. No.: US 2010/0167260 A1
(43) Pub. Date: Jul. 1, 2010

(54) Use of N-Piperidine Derivative Compositions for Protecting Biological Systems

(75) Inventors: Gianfranco Merizzi, Torino (IT); Antonio Soleti, Nichelino (Torino) (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MEDESTEA RESEARCH & PRODUCTION SPA, Colleretto Giacosa (Torino) (IT)

(21) Appl. No.: 12/161,232

(22) PCT Filed: Jan. 18, 2007
(86) PCT No.: PCT/EP2007/050502

§ 371 Date: Jul. 17, 2008

(30) Foreign Application Priority Data
Jan. 19, 2006 (EP) 06100589.8

(51) Int. Cl. A01N 1/02

(52) U.S. Cl. 435/1.2; 435/2

(57) ABSTRACT

The present invention relates to compositions and the use of such compositions in the formulation of preservation solutions for protecting mammalian (including human) biological systems such as biotechnological preparations (including recombin 10d3 ant proteins), organs, tissues (including whole blood and blood derivatives such platelets and plasma) and cells (including red blood cells, pancreatic ss-cells, stem cells and germ cells) from oxidative damage occurring, for example, during the different phases of transplantation and surgery. More particularly, this invention relates to a method for protecting and/or enhancing viability of mammalian biotechnological preparations/cells/tissues/organs during isolation (or harvesting), preservation (or storage), expansion (or colture), transplantation and surgery by using compositions containing effective amount of antioxidant cyclic (bis)-hydroxylamines derived from N-piperidine. Data supplied from the esp@cenet database—Worldwide

The present invention relates to compositions and the use of such compositions in the formulation of preservation solutions for protecting mammalian (including human) biological systems such as biotechnological preparations (including recombinant proteins), organs, tissues (including whole blood and blood derivatives such platelets and plasma) and cells (including red blood cells, pancreatic β-cells, stem cells and germ cells) from oxidative damage occurring, from example, during the different phases of transplantation and surgery. More particularly, this invention relates to a method for protecting and/or enhancing viability of mammalian biotechnological preparations/cells/tissues/organs during isolation (or harvesting), preservation (or storage), expansion (or colture), transplantation and surgery by using compositions containing effective amount of antioxidant cyclic (bis)-hydroxylamines derived from N-piperidine.

The generation of highly reactive free radicals—the superoxide anion (O₂⁺⁻), the perhydroxyl radical (HO₂⁺⁻), the oxygen singleton (^{1A}O₂), the hydroxyl radical (HO⁺) , hydrogen peroxide (H₂O₂), nitrogen dioxide (NO₂), peroxynitrite (NOO⁺) and other (R⁺) radicals (alkyl-L⁺, alkoxy-LO⁺, peroxy-LOO⁺ radicals, etc. has a detrimental effect on the viability of biological systems such as biotechnological preparations (including recombinant proteins), organs, tissues (including whole blood derivatives such as platelets and plasma) or cells (including red blood cells, pancreatic g-cells, stem cells and germ cells) during isolation, preservation (or storage), expansion (or colture), transplantation or organ (e.g. cardiopulmonary) bypass surgery (see, for example, Bottino R., Diabetes 53, 2559-2567, 2004).

It is known, for example, that successful organ transplantation is often limited due to ischemic/reperfusion injury: the failure originates from the risks of degradations, or even necrosis, of the graft, which manifest themselves during the reoxygenation of the transplanted organ and which are associated to the ischemia, usually prolonged, occurring between initiation of the transplantation itself from the donor and the completion of the implantation in the recipient. Minimizing the morbidity and mortality associated with graft tissue damage during ischemia and reperfusion injury is thus of enormous clinical relevance (see, for example, Tsuchihashi S. I. et al., Curr. Opin. Organ Transplant. 9, 145-152, 2004).

An ischemia of five to six hours due to “heat ischemia”, occurring during the removal from the donor, “cold ischemia”, following the hypothermic storage phase (universally accepted as the basic strategy for the maintenance and transport of organs for transplantation), and “global ischemia”, occurring during implantation, constitutes (for example, in the case of heart) the upper tolerable limit, and does not rule out a large number of accidents. Of course, other organs/tissues such as liver, skin/muscle flap, trachea, amputated digits, pancreas, kidney, lung, intestine or cells (e.g. pancreatic islet cells), are subject to oxidative damage when removed from the host prior to (or during) culture, expansion and transplantation. In the latter case, during the reperfusion of the organ in the recipient, free oxygen radicals are actually produced in copious amount (see for example Vega D. J. et al., Am. Thorac. Surg. 71, 1442-1447, 2001).

To overcome the limit, many different organ preservation solutions have been designed, as investigators have sought to lengthen the time that an organ may remain extra-corporeally, as well as to maximize the function of the organs/cells following implantation.

Examples of conventional preservation solutions are the following:
Celsior solution, disclosed in Menosche P. et al., Eur. J. Cardiothoracic Surg. 8, 207-215, 1994;
University of Wisconsin solution, disclosed in U.S. Pat. No. 4,798,824;
Collins solution, disclosed in Maurer E. J. et al., Transplant. Proc. 22, 548-550, 1990;
Euro-Collins solution, disclosed by Collins G. M. and Holsz N. A., Surgery 39, 432, 1976 & Eurotransplant Formation Annual, Report, 1976;
Columbia University solution, disclosed in U.S. Pat. No. 5,552,267;
Krebs-Henseleit solution, disclosed by Sharek H. J. et al., Pfluger's Arch. 354, 349-365, 1975;
Stanfort solution, disclosed in Swanson D. K. et al., J. Heart Transpl. 7, 456, 467, 1988;
Lactate Ringer's solution, also namely Hartmann's solution, disclosed in Dreikorn K. et al., Eur. Urol. 6, 221-224, 1980;
S. Thomas II solution, disclosed by Jynge P. et al., Scand. J. Thorac. Cardiov. Surg. Suppl. 30, 1-28, 1981;
CRMBM solution, disclosed in Bernard M. et al., J. Heart Lung Transplant 18, 572-581, 1999;
LYPS solution, disclosed in Michel P. et al., J. Heart Lung Transplant 21, 1030-1039, 2002;
ET-Kyoto solution, disclosed in Chen F. et al., Yonsei Med. J. 45, 1107-1114, 2004;
CMU-1 solution, disclosed in Cheng Y. et al., World J. Gastroenterol. 11, 2522-2525, 2005;
Polysol solution, disclosed in Bessems M. et al., Transpl. Proc. 37, 326-328, 2005.

To date, however, the above cited preservation solutions present only limited advantages in efficaciously fighting oxidative damage. This is due to the fact that the protective agents contained in the solutions, which are conventional substances (including antioxidants) capable of counteracting the production or the effects of reactive free radicals, such as trolox derivatives of vitamin E (Trolox C), allopurinol, desferoxamine, indanoindoles, catalase, peroxidase, superoxide dismutase, glutathione, N-acetylcysteine, nitroxides, ginkgolides, coenzyme Q, β-carotene, cyanidol (see, for example, WO88/05044, U.S. Pat. No. 5,002,965; U.S. Pat. No. 6,054,261; U.S. Pat. No. 5,498,427; U.S. Pat. No. 4,877,810; WO95/02323; WO02/102149) used alone or in combination (see for example Nelson S. K. et al., Biomedicine & Pharmacotherapy 59, 149-157, 2005), are not the best choice for the protection of biological systems against oxidative damage. The limited value of the cited compounds stems from the fact that, for example, antioxidant enzymes can act extracellularly and selectively toward one kind of radical only (e.g. superoxide dismutase toward superoxide anion O₂⁻⁺) and organic compounds such as glutathione (the most widely used agent in preservation solutions) can actually behave as prooxidant (see for example Gnaiger E. et al., Transplantation Proc. 32, 14, 2000) or have no effects if removed from the solution (see for example Urushihara T., Transplantation 53, 750-754, 1992).

The need of the new refined preservation solutions, containing more effective additives toward ischemia and reperfusion injury, is indeed strongly evoked by the international scientific community (see, for example, Kupiec-Weglinski J. W., Curr. Op. Organ Transpl. 9, 130-131, 2004).

To solve these problems, the subjects of the present invention are a method for protecting biological systems and a preservation solution as defined in the appended claims, which are to be intended as a part of the present description.

A first aspect of this invention is to provide effective protective compositions containing antioxidant cyclic hydroxylamines derived form the N-piperidine. These very potent anti-oxidants over conventional ones (e.g. acting toward most, if not all, carbon, nitrogen and oxygen-centered radicals of biological interest including peroxyl, superoxide and peroxynitrite radicals), which now have been found useful for mammalian biological system preservation solutions in accordance with the present invention, are disclosed in U.S. Pat. No. 5,981,548 and PCT/EP2005/001818 as well as processes for their preparation.

A further object of the present invention is the use of such compositions in preservation/perfusion solutions for protecting against oxidative damage mammalian (including humans) biological systems such as biotechnological preparations (including recombinant proteins), organs, tissues (including tissue derivatives such as platelets and plasma) or cells (including stem cells, pancreatic islets, germ cells and red blood cells), during isolation (or harvesting), preservation (e.g. perfusion, storage), expansion (or colture), transplantation and surgery (e.g. cardiopulmonary bypass).

With reference to novel use of N-piperidine derivatives for compositions useful in the preservation solution field, the compound known as: bis(1-hydroxy-2,2,6,6-tetramethyl-4-piperidinyl)decandioate, having the formula

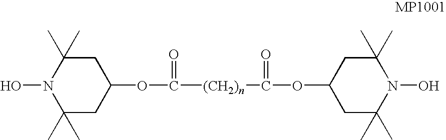

should be preferred and used preferably in the range of 0.001 to 50 mM, preferably in the form of a physiologically acceptable salt. Non limiting examples of these salts are chloride, fumarate and maleate. Chloride is the first choice.

The solutions for preservation of biological materials, according to the invention, may comprise, in addition to the N-piperidine derivative of formula (I) or (III), one or more further antioxidants or protective agents, such as those listed hereinbefore.

The solutions of the invention are preferably substantially isotonic with the biological material to be preserved. As used herein an isotonic solution refers to a solution in which the cells neither swell nor shrink substantially. Preferably, the preservative solutions of the invention have an osmolality substantially equal to that of the biological material to be preserved. However, this is not a requirement of all the inventive solutions, since some solutions may include one or more components which raise the osmolality of the solution but are able to cross semi-permeable membranes freely, thus raising the osmotic pressure equally on both sides of the cell membranes. By way of example, the osmolality may range from about 270 to 450 mOsm/l.

Preferably the solutions of the invention comprise a physiological acceptable amount of ions, selected from the group consisting of sodium, potassium, calcium, magnesium, mono- and bi-acidic phosphate, bicarbonate, chloride ions and mixtures thereof. Preferred are preservation solutions comprising at least 4 of the above quoted ions. Typical amounts of potassium, sodium, magnesium, calcium and chloride ions are for instance shown in U.S. Pat. No. 5,498,427 (cf. claim 6). The solution may further comprise a carbohydrate source, such as glucose and mannitol. The pH of the solution is typical between 7.4 and 8.5.

According to a preferred embodiment the compositions comprise desferoxamine preferably at the final concentration within the range of from 0.01 to 55 mM, Na⁺ preferably from 0.1 to 200 mM and K⁺, preferably from 0.2 to 220 mM. The determination of the optimal dosage is amongst the possible selections that are open to a person skilled in the art, and widely reported in literature.

According to the invention, the new compositions can be used as preservation solution on biological system.

Alternatively at least one N-piperidine derivative singularly or together with desferoxamine, or the combination of both K⁺ and Na⁺, if not originally present can be used as additive to commercially available preservation solutions.

Ingredient/s should be packaged in a manner such as is a common practice with this type of compounds, such as in ampoule under an inert atmosphere or in vacuum, so that the component/s is to be reconstituted in a suitable physiologically acceptable buffer, or directly into conventional preservation solutions, prior to use.

The composition of the invention is preferably for use in the preservation of biological systems or materials of human origin, but it can also be used for preservation of materials of animal origin, such as farm animals, cats, dogs, cattle, sheep and pigs.

The following example enables a person skilled in the art to carry out the invention. The example is therefore illustrative of this invention and is included solely as an embodiment of the invention and not as a limitation. The use of the invention in an animal model of organ (rabbit heart) preservation experiment, by way of example cold ischemia, is therefore described.

The example which follows, refers to the annexed drawings, wherein:

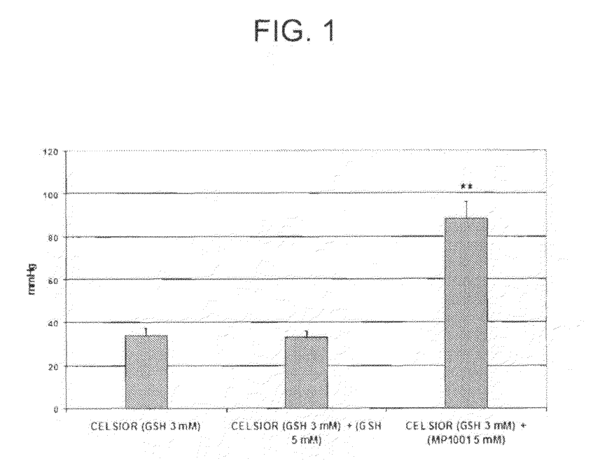

FIG. 1 is a diagram showing the developed pressure expressed in mmHg after heart reperfusion (1 h) under equimolar antioxidant potency, GSH vs MP1001 **p<0.01 (Wilcoxon's rank method);

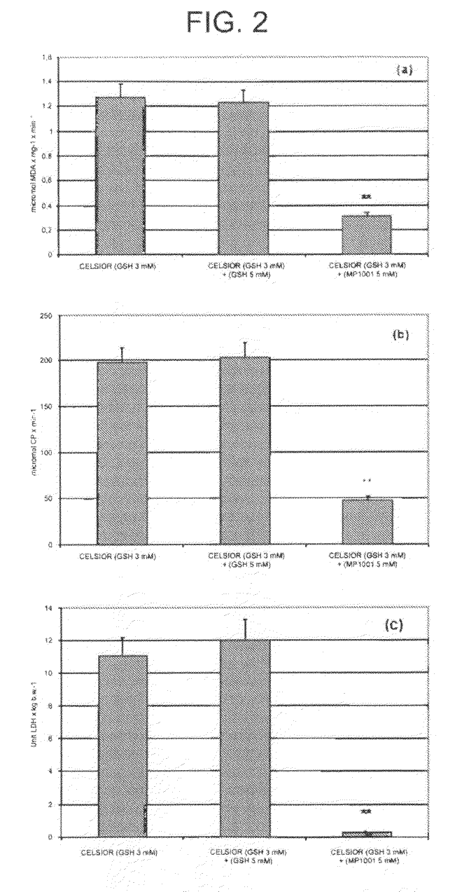

FIG. 2 is a diagram showing the expression of lipid peroxidation, carbonyl proteins and LDH levels in rabbit hearts after 1 h reperfusion under equimolar antioxidant potency GSH vs MP1001 **p<0.01 (Wilcoxon's rank method); and

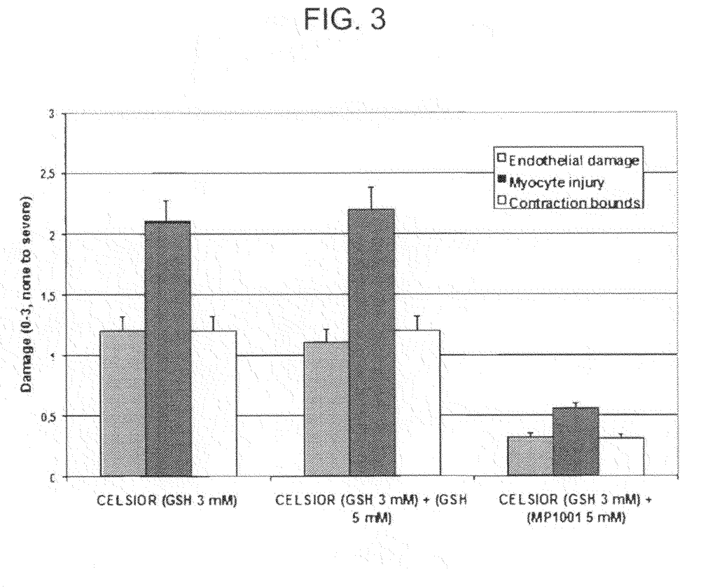

FIG. 3 is a diagram showing the histological analysis of rabbit hearts after 1 h reperfusion under equimolar anti-oxidant potency GSH vs MP1001 **p<0.01 (Wilcoxon's rank method).

### EXAMPLE

Reports conflict on the benefit of preservation solutions for cardiac graft preservation during hypothermia. Cold storage solutions can be classified into 2 types, extracellular and intracellular, based on K⁺ and Na⁺ concentrations. In other words, extracellular-type solutions mimic extracellular fluids—[Na⁺]≧70 mmol/L, [K⁺]=5˜30 mmol/L—and intracellular-type solutions mimic intracellular fluids—[Na⁺]<70 mmol/L, [K⁺]=30˜125 mmol/L. Recent comparative investigations on the most widely used solutions showed that extracellular-type solutions provided better preservation that did intracellular-type ones (see for example Michel P. et al., J. Heart & Lung Transpl. 21, 1030-1035, 2002). Among extracellular solutions, Celsior showed high efficacy for heart preservation. In addition, growing evidences from prospective multicenter randomized clinical trials support the use of Celsior preservation solution in multiple organ harvesting as a universal cold storage solution for intra-abdominal organs and for intrathoracic organs as well (see for example Faenza A. et al., Transplantation 72, 1274-1277, 2001).

For these reasons Celsior solution is becoming the gold standard solution worldwide and therefore selected as the most indicative for checking the efficacy of chemical compounds or compositions according to the present invention.

A brief discussion of a conventional technique for organ (heart) preservation follows, since the method disclosed herein is widely described in literature.

Male New Zealand rabbits (1.4-1.8 kg weight) were kept on a standard laboratory diet supplemented with “Nossan pellet” (both the animals and pellets are available from Nossan Company, Milan, Italy) and were housed for three weeks (relative humidity 50% ±10%, temperature 22° C.±1° C. and in a light/darkness cycle of 12 hours/12 hours, with first light at 7.30 a.m.) prior to the experiments; food and water were available ad libitum.

The hearts were quickly excised from anesthetized animals (55 mg/kg body weight sodium pentobarbital; ten rabbits for each experiment group were used) flushed with the respective experimental solutions and placed in either cold (4° C.) Celsior and Celsior plus 5 mM MP1001 or Celsior plus GSH 5 mM for 24 hours. Because Celsior standard solution contains 3 mM reduced glutathione (GSH), comparative experiments in term of “total antioxidant power” using equimolar antioxidant amount (e.g. adding 5 mM MP1001 or 5 mM GSH to Celsior) were performed.

At the end of cold preservation, the organs were then reperfused in a Langerdoff working heart model with oxygenated Krebs-Henseleit buffer (120 mM NaCl, 25 mM NaHCO₃, 4.9 mM KCl, 1.2 mM KH₂PO₄, 2.5 mM CaCl₂, 1.25 MgSO₄ and 10 mM glucose). The buffers were bubbled regularly with a mixture of O₂ (95%) and CO₂ (5%); the CO₂ helped maintain the buffer at a physiological pH (7.4). In the mean time, the apparatus had extensive water-jacketing connected to a water heater that maintained buffers and hearts at 37° C. The buffers was filtered through a Gelman GA-4, 0.8 μm metrical, membrane before the use. A saline-filled latex balloon connected through a pressure transducer to a polygraph recorder was inserted into the left ventricle through a left atriotomy and secured by a suture to the mitrial annulus. The suture was loose enough to allow fluid drainage from the ventricle.

After 24 hours of cold preservation and reperfusion for 1 hour, the developed pressure (as a measure of protection) of the hearts preserved in Celsior (standard/control) was a mean of 34±9.55 mmHg. The organs could no longer convert and maintain a good sinus rhythm and contract efficiently. We determined that this level of recovery was not sufficient and proceeded to add the cardioprotective antioxidant MP1001 (5 mM) or GSH (5 mM, to have a final, equimolar 8 mM “antioxidant concentration”).

FIG. 1 clearly shows that the antioxidant MP1001 when added to standard Celsior solution is able to provide a marked and significant (p<0.01) protection. When the hearts were preserved with this modified solution, cardioplegia for 24 hours and reperfused, the recovery as measured by developed pressure was 88±9.02 mmHg. On the contrary, the presence in Celsior of an equimolar (8 mM GSH) amount of the most used conventional antioxidant (reduced glutathione) did not provide any additional protection compared to standard solution (3 mM GSH).

Lipid peroxidation was determined by quantification of the release of malondialdeyde (MDA) accumulated in cells which was used as biomarker, essentially according to Buege Y. A. & Aust S. G., Method Enzymol. 52, 302-310, 1978. FIG. 2a clearly shows the high development of lipid peroxidation products in the presence of standard Celsior solution. The use of additional 5 mM GSH did not significantly modify this parameter. By contrast, the addition of MP1001 to Celsior preservation solution provoked a marked and significant (p<0.01) reduction of the lipid peroxidation (1.28±0.37 Celsior vs 0.31±0.10 Celsior+MP1001). Oxidative modification of proteins is a typical biomarker of reperfusion injury as a consequences of attack by free reactive radicals (Fundam. Clin. Pharmacol. 19, 491-496, 2005). FIG. 2b shows the presence of a significant (p<0.01) and concomitant decrease in the levels of both peroxidation and carbonyl proteins determined by MP1001 (198±18 Celsior vs 48±11 Celsior+MP1001). Again, LDH levels in the perfusate was significantly (p<0.01) reduced by MP1001 when compared to Celsior (FIG. 2c) (11±2.5 Celsior vs 0.3±0.1 Celsior+MP1001). Both carbonyl proteins and LDH were not modified by GSH supplement.

It is known that the disruption of the myocardial architecture indicate reperfusion damage. The hystopathological analysis of tissue graded for the degree of myocyte injury, edema, and endotelial damage was consistent with previous results showing the least amount of disruption of the myocardial architecture. The hystopathological analysis shows the protection of hearts stored in the presence of MP1001 as compared to GSH (FIG. 3). Hearts sustained less injury by all criteria examined.

These tests show that, according to the present invention, the presence of MP1001 in Celsior solution is able to drastically reduce the ischemic damage after reperfusion of stored heart compared to storage in standard Celsior solution. These data demonstrate the capacity of the compound of the invention to exert an exceptional protective effect of ischemic hearts thus improving the viability of cold-preserved organs.

This suggests that the compounds of the invention offer a novel method to prepare preservation solutions for biological systems.

1. A method for preserving and/or enhancing the viability ex vivo of a mammalian biological system, comprising contacting said biological system with a preservation solution comprising a compound of formula: 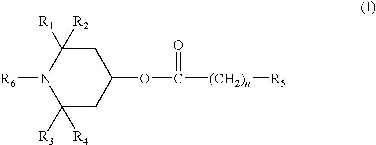
in which:
R₁, R₂, R₃ and R₄ are, independently of one another, hydrogen or alkyl having from 1 to 6 carbon atoms, R₆ is oxyl or hydroxyl, and R₅ is 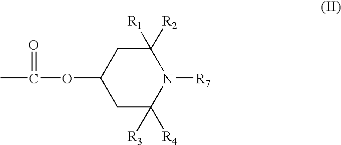
in which R₁, R₂, R₃ and R₄ are, independently of one another, hydrogen or alkyl having from 1 to 6 carbon atoms, R₇ is oxyl or hydroxyl, and n is a whole number from 2 to 14; or a physiologically acceptable salt of said compound.

2. A method according to claim 1, in which R₁, R₂, R₃ and R₄ are, independently of one another, an alkyl having from 1 to 3 carbon atoms and R₅ is: 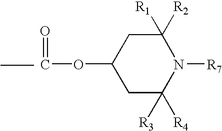
in which R₁, R₂, R₃ and R₄ are, independently of one another, an alkyl having from 1 to 3 carbon atoms, R₇ is oxyl or hydroxyl, and n is a whole number from 6 to 10.

3. A method according to claim 1, in which the compound is of formula 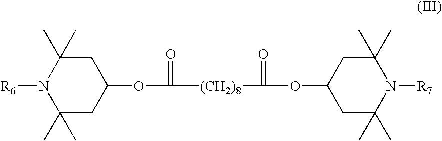
in which R₆ and R₇ are identical or different and are selected from oxyl and hydroxyl.

4. A method according to claim 1, in which the biological systems are biotechnological preparations such as recombinant proteins, organs such as heart, liver, pancreas, kidney, lung, intestine, trachea as well as amputated organs such as digits, tissues such as skin/muscle flaps, whole blood, blood derivatives such as platelets and plasma, and cells such as red blood cells, pancreatic islet cells, stem cells and germ cells.

5. A method according to claim 1, in which the compounds are under the form of physiologically acceptable salts, said salts being either chloride, fumarate and maleate.

6. A method according to claim 1, in which said compound is present in the preservation solution in an antioxidant effective amount, preferably in the range of from 0.001 to 50 mM.

7. A method according to claim 1, wherein said compound is added to a standard commercially available preservation solution that is either Celsior solution, University of Wisconsin solution (UW-1), Modified University of Wisconsin solution (UW-2), Krebs-Henseleit solution, St. Thomas 1 (STH-1) and 2 (STH-2) solution, Collins solution, Euro-Collins solution (EC), Lactated Ringer's solution, Columbia University solution, Stanford solution (STF), Lyon Preservation solution (LYPS), Bretschneider solution (HTK), RMBM solution, ET-Kioto solution, CMV-1 solution, Polysol solution, NaCl solution.

8. A method according to claim 1, in which said compound is used in combination with desferoxamine preferably within the range of from 0.01 to 55 mM and, if not already present, Na⁺, preferably at the final concentration within the range of from 0.1 to 200 mM, and K⁺, preferably at the final concentration within the range of from 0.2 to 220 mM.

9. A method according to claim 1, in which said compound is comprised in an isotonic aqueous buffer solution comprising desferoxamine, within the range of from 0.01 to 55 mM, Na⁺, within the range of from 0.1 to 200 mM, and K⁺, within the range of from 0.2 to 220 mM.

10. A method according to claim 1, wherein the biological system is contacted with the preservation solution by infusion, immersion, flushing, perfusion or culture.

11. An aqueous saline-based solution for the preservation of biological materials, particularly for storage, perfusion and reperfusion ex vivo of mammalian organs, comprising: an effective antioxidant amount of a compound of formula (I) or (III) or a physiological acceptable salt thereof; and a preservative or antioxidant compound selected from trolox derivatives of vitamin E (Trolox C), allopurinol, deferoxamine, indaindoles, catalase, peroxidase, superoxide dismutase, glutathione, N-acetylcysteine, nytroxides, ginkolides, coenzyme Q, β-carotene, cyanidol and mixtures thereof.

12. A solution according to claim 11, further comprising a physiologically acceptable amount of an ion selected from sodium, potassium, calcium, magnesium, mono- and bi-acidic phosphate, bicarbonate, chloride and mixtures thereof, preferably a mixture of at least four of said ions.

13. A solution according to claim 12, further comprising a carbohydrate source.

14. A solution according to claim 11, having a pH of from 7.4 to 8.5.

15. A solution according to claim 11, comprising desferoxamine, preferably in the concentration of from 0.01 to 55 mM.

16. A solution according to claim 11, further comprising sodium ions preferably from 0.1 to 200 mM and potassium ions preferably from 0.2 to 220 mM.
